(19) United States
(12) Patent Application Publication
(10) Pub. No.: US 2023/0114331 A1
(43) Pub. Date: Apr. 13, 2023

(54) SAMPLE SUPPORT, IONIZATION METHOD, AND MASS SPECTROMETRY METHOD

(71) Applicant: HAMAMATSU PHOTONICS K.K., Hamamatsu-shi, Shizuoka (JP)

(72) Inventors: Masahiro KOTANI, Hamamatsu-shi, Shizuoka (JP); Takayuki OHMURA, Hamamatsu-shi, Shizuoka (JP); Akira TASHIRO, Hamamatsu-shi, Shizuoka (JP)

(73) Assignee: HAMAMATSU PHOTONICS K.K., Hamamatsu-shi, Shizuoka (JP)

(21) Appl. No.: 17/908,105

(22) PCT Filed: Jan. 15, 2021
(86) PCT No.: PCT/JP2021/001302

§ 371 Date: Aug. 30, 2022

(30) Foreign Application Priority Data
Mar. 6, 2020 (JP) 2020-038909

(51) Int. Cl. H01J 49/04; H01J 49/16

(52) U.S. Cl. CPC H01J 49/0409; H01J 49/161

(57) ABSTRACT

A sample support used for ionizing a component of a sample includes: a substrate having a first surface, a second surface opposite the first surface, and a plurality of through-holes that are open on the first surface and on the second surface; a conductive layer provided on at least the first surface; and an anionizing agent provided in the plurality of through-holes to anionize the component.

### TECHNICAL FIELD

The present disclosure relates to a sample support, an ionization method, and a mass spectrometry method.

### BACKGROUND ART

As a sample support used for ionizing a component of a sample, a sample support has been known which includes a substrate having a first surface, a second surface opposite the first surface, and a plurality of through-holes that are open on the first surface and on the second surface (for example, refer to Patent Literature 1).

### CITATION LIST

### Patent Literature

Patent Literature 1: Japanese Patent No. 6093492

### SUMMARY OF INVENTION

### Technical Problem

In mass spectrometry using the above-described sample support, the component of the sample may be cationized by various types of atoms contained in air, a solvent, or the like. In such a case, even when the component (molecules) has the same molecular weight, the component is detected as a plurality of types of sample ions having different molecular weights, so that a signal intensity for the component having the same molecular weight is dispersed and, as a result, the sensitivity of mass spectrometry decreases, which is a concern.

Therefore, an object of the present disclosure is to provide a sample support, an ionization method, and a mass spectrometry method that make highly sensitive mass spectrometry possible.

### Solution to Problem

According to the present disclosure, there is provided a sample support used for ionizing a component of a sample, the support including: a substrate having a first surface, a second surface opposite the first surface, and a plurality of through-holes that are open on the first surface and on the second surface; a conductive layer provided on at least the first surface; and an anionizing agent provided in the plurality of through-holes to anionize the component.

The sample support includes the substrate having the first surface, the second surface opposite the first surface, and the plurality of through-holes that are open on the first surface and on the second surface. Accordingly, when the component of the sample is introduced into the plurality of through-holes, the component of the sample stays on the first surface side. Further, when the first surface of the substrate is irradiated with an energy ray such as laser light while a voltage is applied to the conductive layer, energy is transmitted to the component of the sample on the first surface side. The component of the sample is ionized by the energy to generate sample ions. Here, the sample support includes the anionizing agent that is provided in the plurality of through-holes to anionize the component. For this reason, the component of the sample stays on the first surface side in a state where the component is mixed with a part of the anionizing agent. Accordingly, when the energy is transmitted to the component and to the part of the anionizing agent, the component is more easily anionized into predetermined sample ions than being cationized by various types of atoms contained in air, a solvent, or the like. Namely, the component having the same molecular weight is easily ionized into one type of sample ions having the same molecular weight. Therefore, the dispersion of a signal intensity for the component having the same molecular weight is suppressed. As a result, according to this sample support, highly sensitive mass spectrometry is possible.

In the sample support of the present disclosure, the anionizing agent may be provided on at least the second surface side. According to this configuration, imaging mass spectrometry to capture an image of a two-dimensional distribution of molecules constituting the sample can be performed with high sensitivity. Namely, when the sample support is disposed on the sample such that the second surface faces the sample and the anionizing agent comes into contact with the sample, the component of the sample is mixed with a part of the anionizing agent and moves from the second surface side to the first surface side through each of the through-holes. For this reason, the part of the anionizing agent is uniformly distributed at each position on the first surface side. Accordingly, the component can be uniformly anionized at each position on the first surface side. Therefore, the occurrence of unevenness in the image of the two-dimensional distribution of the molecules constituting the sample can be suppressed, and mass spectrometry can be performed with high sensitivity.

In the sample support of the present disclosure, the anionizing agent may be provided on at least the first surface side. According to this configuration, mass spectrometry to analyze a mass spectrum can be performed with high sensitivity. Namely, for example, both when the component of the sample in a liquid state is introduced into each of the through-holes from the first surface side and when the component of the sample in a liquid state is introduced into each of the through-holes from the second surface side, the component of the sample stays on the first surface side in a state where the component is reliably mixed with the part of the anionizing agent. For this reason, the component can be reliably anionized, and mass spectrometry can be performed with high sensitivity.

In the sample support of the present disclosure, the anionizing agent may be provided on at least the second surface side and the first surface side. According to this configuration, both image mass spectrometry and mass spectrometry to analyze a mass spectrum can be performed with high sensitivity.

In the sample support of the present disclosure, the anionizing agent may be provided as an evaporation film, a sputtering film, or an atomic deposition film. According to this configuration, an average grain size of crystals of the anionizing agent can be made relatively small, and the crystals of the anionizing agent can be uniformly distributed. Accordingly, the spatial resolution in mass spectrometry can be increased.

In the sample support of the present disclosure, the anionizing agent may be provided as a coating dry film. According to this configuration, the anionizing agent can be easily provided.

In the sample support of the present disclosure, the anionizing agent may contain at least one selected from a fluoride, a chloride, a bromide, and an iodide. According to this configuration, the ionization of the component of the sample can be efficiently performed by applying an anionizing agent suitable for ionizing the component of the sample according to the type of the component of the sample.

In the sample support of the present disclosure, a plurality of measurement regions in which the sample is disposed may be formed in the substrate. According to this configuration, the ionization of the component of the sample can be performed in each of the plurality of measurement regions.

According to the present disclosure, there is provided a sample support used for ionizing a component of a sample, the support including: a substrate having conductivity and having a first surface, a second surface opposite the first surface, and a plurality of through-holes that are open on the first surface and on the second surface; and an anionizing agent provided in the plurality of through-holes to anionize the component.

According to this sample support, the conductive layer can be omitted, and the same effects as those of the sample support including the conductive layer described above can be obtained.

An ionization method of the present disclosure includes: a first step of preparing the sample support; a second step of introducing the component of the sample into the plurality of through-holes; and a third step of ionizing the component of the sample by irradiating the first surface with an energy ray while applying a voltage to the conductive layer.

In the ionization method, when the component of the sample is introduced into the plurality of through-holes, the component of the sample stays on the first surface side. Further, when the first surface of the substrate is irradiated with an energy ray while a voltage is applied to the conductive layer, energy is transmitted to the component of the sample on the first surface side. The component of the sample is ionized by the energy to generate sample ions. Here, the sample support includes the anionizing agent that is provided in the plurality of through-holes to anionize the component. For this reason, the component of the sample stays on the first surface side in a state where the component is mixed with a part of the anionizing agent. Accordingly, when the energy is transmitted to the component and to the part of the anionizing agent, the component is more easily anionized into predetermined sample ions than being cationized by various types of atoms contained in air, a solvent, or the like. Namely, the component having the same molecular weight is easily ionized into one type of sample ions having the same molecular weight. Therefore, the dispersion of a signal intensity for the component having the same molecular weight is suppressed. As a result, according to this ionization method, highly sensitive mass spectrometry is possible.

An ionization method of the present disclosure includes: a first step of preparing the sample support; a second step of introducing the component of the sample into the plurality of through-holes; and a third step of ionizing the component of the sample by irradiating the first surface with an energy ray while applying a voltage to the substrate.

According to this ionization method, the conductive layer can be omitted, and the same effects as when the sample support including the conductive layer as described above is used can be obtained.

A mass spectrometry method of the present disclosure includes: each step of the ionization method; and a fourth step of detecting the ionized component.

According to this mass spectrometry method, as described above, highly sensitive mass spectrometry is possible.

In the mass spectrometry method of the present disclosure, in the fourth step, the ionized component may be detected by a negative ion mode. Accordingly, the ionized component can be appropriately detected.

### Advantageous Effects of Invention

According to the present disclosure, it is possible to provide the sample support, the ionization method, and the mass spectrometry method that make highly sensitive mass spectrometry possible.

### BRIEF DESCRIPTION OF DRAWINGS

FIG. 1 is a plan view of a sample support of a first embodiment.

FIG. 2 is a cross-sectional view of the sample support taken along line II-II shown in FIG. 1.

FIG. 3 is an enlarged image of a substrate of the sample support shown in FIG. 1.

FIG. 4 is a view showing steps of a mass spectrometry method using the sample support shown in FIG. 1.

FIG. 5 is a plan view and a cross-sectional view of a sample support of a second embodiment.

FIG. 6 is a cross-sectional view of the sample support shown in FIG. 5.

FIG. 7 is a view showing steps of a mass spectrometry method using the sample support shown in FIG. 5.

FIG. 8 is graphs showing mass spectra obtained by respective mass spectrometry methods of a comparative example and an example.

FIG. 9 is a cross-sectional view of a sample support of a modification example.

FIG. 10 is a cross-sectional view of a sample support of a modification example.

FIG. 11 is a cross-sectional view of a sample support of a modification example.

FIG. 12 is a view showing steps of a mass spectrometry method of a modification example.

### DESCRIPTION OF EMBODIMENTS

Hereinafter, embodiments of the present disclosure will be described in detail with reference to the drawings. Incidentally, in the drawings, the same or equivalent portions are denoted by the same reference signs, and a duplicated description will be omitted.

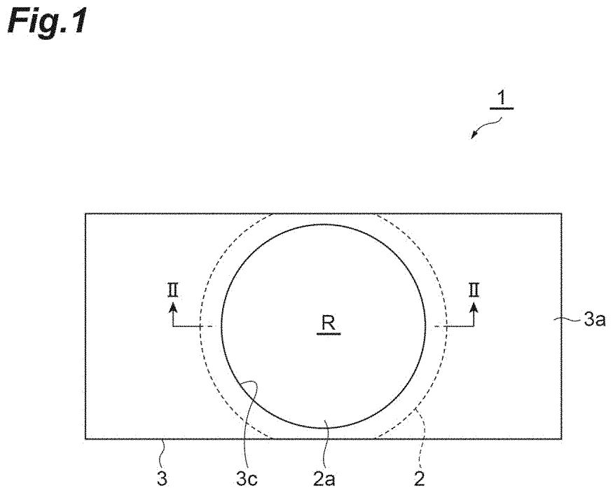

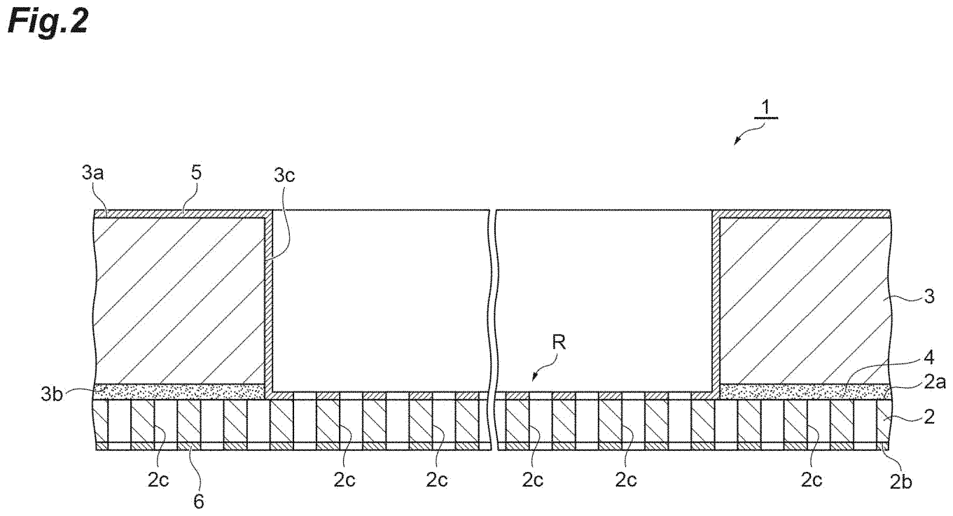

### First Embodiment

[Configuration of sample support] As shown in FIGS. 1 and 2, a sample support 1 used for ionizing a component of a sample includes a substrate 2, a frame 3, a conductive layer 5, and an anionizing agent 6. The substrate 2 has a first surface 2a, a second surface 2b, and a plurality of through-holes 2c. The second surface 2b is a surface opposite the first surface 2a. The plurality of through-holes 2c extend along a thickness direction of the substrate 2 (direction perpendicular to the first surface 2a and to the second surface 2b) and are open on each of the first surface 2a and the second surface 2b. In the present embodiment, the plurality of through-holes 2c are uniformly (with a uniform distribution) formed in the substrate 2.

For example, the substrate 2 is formed in a circular plate shape from an insulating material. A diameter of the substrate 2 is, for example, approximately several cm, and a thickness of the substrate 2 is, for example, 1 to 50 μm. A shape of the through-hole 2c is, for example, a substantially circular shape when viewed in the thickness direction of the substrate 2. A width of the through-holes 2c is, for example, 1 to 700 nm.

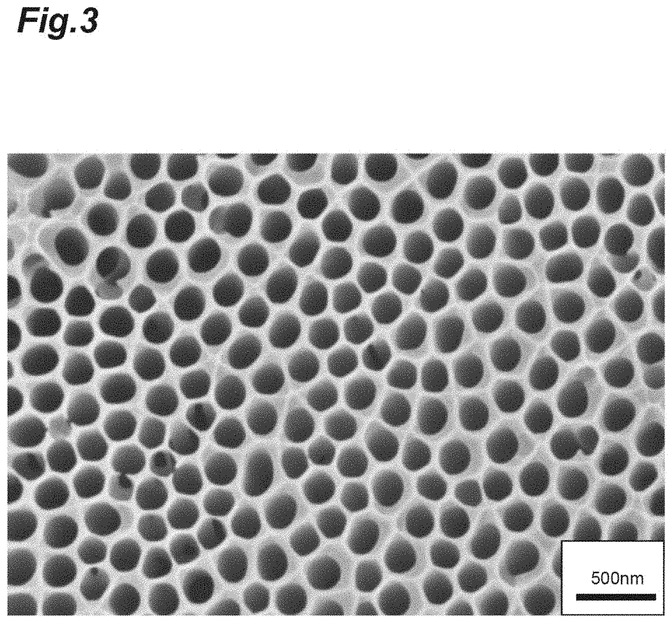

The width of the through-holes 2c is a value obtained as follows. First, an image of each of the first surface 2a and the second surface 2b of the substrate 2 is acquired. FIG. 3 shows one example of a SEM image of a part of the first surface 2a of the substrate 2. In the SEM image, black portions are through-holes 2c, and white portions are partition wall portions between the through-holes 2c. Subsequently, for example, binarization processing is performed on the acquired image of the first surface 2a to extract a plurality of pixel groups corresponding to a plurality of first openings (openings on a first surface 2a side of the through-holes 2c) in a measurement region R, and a diameter of a circle having an average area of the first openings is acquired based on the size per one pixel. Similarly, for example, binarization processing is performed on the acquired image of the second surface 2b to extract a plurality of pixel groups corresponding to a plurality of second openings (openings on a second surface 2b side of the through-holes 2c) in the measurement region R, and a diameter of a circle having an average area of the second openings is acquired based on the size per one pixel. Then, an average value of the diameter of the circle acquired for the first surface 2a and the diameter of the circle acquired for the second surface 2b is acquired as a width of the through-holes 2c.

As shown in FIG. 3, the plurality of through-holes 2c having a substantially constant width are uniformly formed in the substrate 2. An opening ratio of the through-holes 2c in the measurement region R (ratio of a region occupied by all the through-holes 2c to the measurement region R when viewed in the thickness direction of the substrate 2) is practically 10 to 80%, particularly preferably 20 to 40%. The plurality of through-holes 2c may be irregular in size or the plurality of through-holes 2c may be partially connected to each other.

The substrate 2 shown in FIG. 3 is an alumina porous film formed by anodizing aluminum (Al). Specifically, the substrate 2 can be obtained by performing an anodizing treatment on Al substrate and by peeling off an oxidized surface portion from the Al substrate. Incidentally, the substrate 2 may be formed by anodizing a valve metal other than Al, such as tantalum (Ta), niobium (Nb), titanium (Ti), hafnium (Hf), zirconium (Zr), zinc (Zn), tungsten (W), bismuth (Bi), or antimony (Sb) or may be formed by anodizing silicon (Si).

As shown in FIGS. 1 and 2, the frame 3 has a third surface 3a, a fourth surface 3b, and an opening 3c. The fourth surface 3b is a surface opposite the third surface 3a and is a surface on a substrate 2 side. The opening 3c is open on each of the third surface 3a and the fourth surface 3b. The frame 3 is attached to the substrate 2. In the present embodiment, a region along an outer edge of the substrate 2 on the first surface 2a of the substrate 2 and a region along an outer edge of the opening 3c on the fourth surface 3b of the frame 3 are fixed to each other by an adhesive layer 4.

The material of the adhesive layer 4 is, for example, an adhesive material that releases a small amount of gas (low melting point glass, an adhesive agent for use in vacuum, or the like). In the sample support 1, a portion of the substrate 2 corresponding to the opening 3c of the frame 3 functions as the measurement region R in which the component of the sample moves from the second surface 2b side to the first surface 2a side through the plurality of through-holes 2c. The frame 3 facilitates the handling of the sample support 1 and suppresses the deformation of the substrate 2 caused by a change in temperature or the like.

The conductive layer 5 is provided on the first surface 2a side of the substrate 2. The conductive layer 5 is directly (namely, without another film or the like interposed therebetween) provided on the first surface 2a. Specifically, the conductive layer 5 is continuously (integrally) formed in a region corresponding to the opening 3c of the frame 3 on the first surface 2a of the substrate 2 (namely, a region corresponding to the measurement region R), on an inner surface of the opening 3c, and on the third surface 3a of the frame 3. The conductive layer 5 covers a portion of the first surface 2a of the substrate 2 in the measurement region R, the through-holes 2c not being formed in the portion. Namely, each of the through-holes 2c is exposed to the opening 3c in the measurement region R. Incidentally, the conductive layer 5 may be indirectly (namely, with another film or the like) provided on the first surface 2a.

The conductive layer 5 is made of a conductive material. Meanwhile, it is preferable that as the material of the conductive layer 5, metal having a low affinity (reactivity) with the sample and a high conductivity is used for reasons to be described below.

For example, when the conductive layer 5 is made of metal such as copper (Cu) having a high affinity with a sample such as a protein, in the process of ionization of the sample, the sample is ionized in a state where Cu atoms adhere to molecules of the sample and, as a result, the ionized sample is detected as Cu adducts, so that a detection result in a mass spectrometry method shifts, which is a concent. Therefore, it is preferable that a precious metal having a low affinity with a sample is used as the material of the conductive layer 5.

On the other hand, the higher the conductivity of the metal is, the easier it is to apply a constant voltage easily and stably. For this reason, when the conductive layer 5 is made of metal having a high conductivity, a voltage can be uniformly applied to the first surface 2a of the substrate 2 in the measurement region R. In addition, it is preferable that the material of the conductive layer 5 is metal capable of efficiently transmitting the energy of laser light with which the substrate 2 is irradiated, to the sample through the conductive layer 5. For example, when the sample is irradiated with standard laser light (for example, third harmonic Nd-YAG laser having a wavelength of approximately 355 nm, nitrogen laser having a wavelength of approximately 337 nm, or the like) in matrix-assisted laser desorption/ionization (MALDI) or the like, it is preferable that the material of the conductive layer 5 is Al, gold (Au), platinum (Pt), or the like having a high absorptivity in the ultraviolet region.

From the above viewpoint, it is preferable that for example, Au, Pt, or the like is used as the material of the conductive layer 5. In the present embodiment, the material of the conductive layer 5 is Pt. The conductive layer 5 is formed with a thickness of approximately 1 nm to 350 nm, for example, by a plating method, an atomic layer deposition (ALD) method, an evaporation method, a sputtering method, or the like. In the present embodiment, a thickness of the conductive layer 5 is, for example, approximately 20 nm. Incidentally, for example, chromium (Cr), nickel (Ni), titanium (Ti), or the like may be used as the material of the conductive layer 5.

The anionizing agent 6 is provided in the plurality of through-holes 2c. The fact that the anionizing agent 6 is provided in the plurality of through-holes 2c means that the anionizing agent 6 is provided around each of the through-holes 2c. In the present embodiment, the anionizing agent 6 is provided on the second surface 2b side of the substrate 2. The anionizing agent 6 is directly provided on the second surface 2b. The anionizing agent 6 covers a region of the second surface 2b, the plurality of through-holes 2c not being formed in the region. The anionizing agent 6 is provided as an evaporation film, a sputtering film, or an atomic deposition film. Namely, the anionizing agent 6 is formed by the evaporation method, the sputtering method, or the atomic deposition method. The anionizing agent 6 contains at least one selected from a fluoride, a chloride, a bromide, and an iodide. The fluoride, the chloride, the bromide, or the iodide functions to promote the deprotonation of the component of the sample. In the present embodiment, the anionizing agent 6 contains, for example, a chloride such as NaCl. A thickness of the anionizing agent 6 is, for example, approximately 15 nm. An average grain size of crystals of the anionizing agent 6 is, for example, 10 μm or less.

The average grain size of the crystals of the anionizing agent 6 is a value acquired by SEM. Specifically, first, a SEM image of the anionizing agent 6 is acquired. Subsequently, for example, binarization processing is performed on the acquired image of the anionizing agent 6 to extract a plurality of pixel groups corresponding to a plurality of the crystals of the anionizing agent 6, and a diameter of a circle having an average area of the plurality of crystals is acquired as an average grain size of the plurality of crystals based on the size per one pixel.

A part of the anionizing agent 6 can be melted (mixed) in the component of the sample, a solvent, or the like. The anionizing agent 6 promotes the deprotonation of the component of the sample to anionize the component. In the present embodiment, the anionizing agent 6 desorbs protons from the component of the sample. Namely, a signal of the component of the sample is detected as deprotonated molecules because of the desorption of the protons.

[Ionization method and mass spectrometry method] Next, an ionization method and a mass spectrometry method using the sample support 1 will be described. First, the sample support 1 is prepared (first step). The sample support 1 may be prepared by being manufactured by a practitioner of the ionization method and the mass spectrometry method or may be prepared by being purchased from a manufacturer or seller of the sample support 1 or the like.

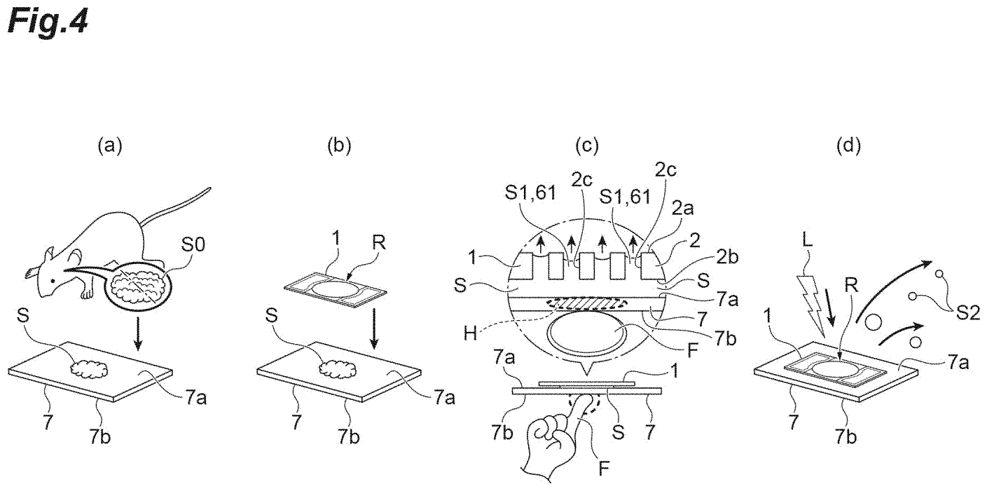

Subsequently, as shown in (a) and (b) in FIG. 4, a component S1 of a sample S (refer to (c) in FIG. 4) is introduced into the plurality of through-holes 2c of the sample support 1 (second step). Specifically, the sample S is disposed on a placement surface 7a of a slide glass (placement unit) 7. The slide glass 7 is a glass substrate on which a transparent conductive film such as an indium tin oxide (ITO) film is formed, and the placement surface 7a is a surface of the transparent conductive film. The sample S is, for example, a thin film-shaped biological sample (hydrous sample) such as a tissue section and is in a frozen state. In the present embodiment, the sample S is acquired by slicing a brain S0 of a mouse. Incidentally, instead of the slide glass 7, a member capable of securing conductivity (for example, a substrate made of a metal material such as stainless steel, or the like) may be used as the placement unit. Subsequently, the sample support 1 is disposed on the placement surface 7a such that the second surface 2b (refer to FIG. 2) of the sample support 1 faces the sample S and the anionizing agent 6 (refer to FIG. 2) comes into contact with the sample S. At this time, the sample support 1 is disposed such that the sample S is located in the measurement region R when viewed in the thickness direction of the substrate 2.

Subsequently, the sample support 1 is fixed to the slide glass 7 using tape having conductivity (for example, carbon tape or the like). Subsequently, as shown in (c) in FIG. 4, a finger F comes into contact with a back surface (surface opposite the placement surface 7a) 7b of the slide glass 7. Accordingly, heat H of the finger F is transmitted to the sample S through the slide glass 7 to unfreeze the sample S. When the sample S is unfrozen, the component S1 of the sample S is mixed with a material 61 of the anionizing agent 6, moves from the second surface 2b side to the first surface 2a side through the plurality of through-holes 2c because of, for example, a capillary phenomenon, and stays on the first surface 2a side because of, for example, surface tension. Namely, the component S1 of the sample S stays on the first surface 2a side in a state where the component S1 is mixed with the material 61 of the anionizing agent 6.

Subsequently, as shown in (d) in FIG. 4, the component S1 of the sample S is ionized (third step). Specifically, the slide glass 7 on which the sample S and the sample support 1 are disposed is disposed on a support portion (for example, a stage) of a mass spectrometer. Subsequently, a laser light irradiation unit of the mass spectrometer is operated to irradiate the region corresponding to the measurement region R on the first surface 2a of the substrate 2 with laser light (energy ray) L while applying a voltage to the conductive layer 5 of the sample support 1 through the placement surface 7a of the slide glass 7 and through the tape by operating a voltage application unit of the mass spectrometer. At this time, at least one of the support portion and the laser light irradiation unit is operated to scan the region corresponding to the measurement region R, with the laser light L.

As described above, when the first surface 2a of the substrate 2 is irradiated with the laser light L while a voltage is applied to the conductive layer 5, energy is transferred to the component S1 of the sample S that has moved to the first surface 2a side. Accordingly, the component S1 of the sample S is ionized, so that sample ions S2 (ionized component S1) are generated. Specifically, when energy is transmitted to the component S1 of the sample S and to the material 61 of the anionizing agent 6 that have moved to the first surface 2a side, the component S1 of the sample S evaporates, and protons are desorbed from molecules of the evaporated component S1. Accordingly, the sample ions S2 are generated. The above steps correspond to the ionization method (in the present embodiment, a laser desorption and ionization method) using the sample support 1.

Subsequently, the released sample ions S2 are detected in an ion detection unit of the mass spectrometer (fourth step). Specifically, the released sample ions S2 move toward a ground electrode provided between the sample support 1 and the ion detection unit, in an accelerated manner because of a potential difference generated between the conductive layer 5 to which the voltage has been applied and the ground electrode, and are detected by the ion detection unit. In the present embodiment, a potential of the conductive layer 5 is lower than a potential of the ground electrode, and negative ions are moved to the ion detection unit. Namely, the sample ions S2 are detected by a negative ion mode. Then, the ion detection unit captures an image of a two-dimensional distribution of molecules constituting the sample S by detecting the sample ions S2 so as to correspond to a scanning position of the laser light L. The mass spectrometer is a scanning type mass spectrometer using a time-of-flight mass spectrometry (TOF-MS) method. The above steps correspond to the mass spectrometry method using the sample support 1.

[Actions and effects] As described above, the sample support 1 includes the substrate 2 having the first surface 2a, the second surface 2b opposite the first surface 2a, and the plurality of through-holes 2c that are open on the first surface 2a and on the second surface 2b. Accordingly, when the component S1 of the sample S is introduced into the plurality of through-holes 2c, the component S1 of the sample S stays on the first surface 2a side. Further, when the first surface 2a of the substrate 2 is irradiated with an energy ray such as the laser light L while a voltage is applied to the conductive layer 5, energy is transmitted to the component S1 of the sample S on the first surface 2a side. The component S1 of the sample S is ionized by the energy to generate the sample ions S2. Here, the sample support 1 includes the anionizing agent 6 that is provided in the plurality of through-holes 2c to anionize the component S 1. For this reason, the component S1 of the sample S stays on the first surface 2a side in a state where the component S1 is mixed with the material 61 of the anionizing agent 6. Accordingly, when the energy is transmitted to the component S1 and to the material 61 of the anionizing agent 6, the component S1 is more easily anionized into the predetermined sample ions S2 by the desorption of a predetermined proton than being cationized by various types of atoms contained in air, a solvent, or the like. Namely, the component S1 having the same molecular weight is easily ionized into one type of the sample ions S2 having the same molecular weight. Therefore, the dispersion of a signal intensity for the component S1 having the same molecular weight is suppressed. As a result, according to the sample support 1, highly sensitive mass spectrometry is possible.

In addition, in the sample support 1, the anionizing agent 6 is provided on the second surface 2b side. According to this configuration, imaging mass spectrometry to capture an image of a two-dimensional distribution of the molecules constituting the sample S can be performed with high sensitivity. Namely, when the sample support 1 is disposed on the sample S such that the second surface 2b faces the sample S and the anionizing agent 6 comes into contact with the sample S, the component S1 of the sample S is mixed with the material 61 of the anionizing agent 6 and moves from the second surface 2b side to the first surface 2a side through each of the through-holes 2c. For this reason, the material 61 of the anionizing agent 6 is uniformly distributed at each position on the first surface 2a side. Accordingly, the component S1 can be uniformly anionized at each position on the first surface 2a side. Therefore, the occurrence of unevenness in the image of the two-dimensional distribution of the molecules constituting the sample S can be suppressed, and mass spectrometry can be performed with high sensitivity.

In addition, in the sample support 1, the anionizing agent 6 is provided as an evaporation film, a sputtering film, or an atomic deposition film. According to this configuration, the average grain size of the crystals of the anionizing agent 6 can be made relatively small, and the crystals of the anionizing agent 6 can be uniformly distributed. Accordingly, the spatial resolution in mass spectrometry can be increased.

In addition, in the sample support 1, the anionizing agent 6 contains at least one selected from a fluoride, a chloride, a bromide, and an iodide. According to this configuration, the ionization (deprotonation) of the component S1 of the sample S can be efficiently performed by applying an anionizing agent suitable for ionizing the component S1 of the sample S according to the type of the component S1 of the sample S.

In addition, the sample support 1 includes the anionizing agent 6 in addition to the conductive layer 5. According to this configuration, each of the conductive layer 5 and the anionizing agent 6 is allowed to appropriately function by optimizing the thickness of each of the conductive layer 5 and the anionizing agent 6. For example, when the same material (here, for example, Ag) is used for both the conductive layer 5 and the anionizing agent 6, it may be difficult to set a thickness of the material to an optimum thickness of each of the conductive layer and the anionizing agent. Namely, the optimum thickness of the conductive layer is larger than the optimum thickness of the anionizing agent. For example, when the thickness of the material is increased (for example, 100 nm or more) to cause the conductive layer to appropriately function, noise is likely to occur as cluster ions, so that the analysis of a signal is difficult, which is a concern.

In addition, according to the ionization method and the mass spectrometry method, as described above, highly sensitive mass spectrometry can be performed.

In addition, in the mass spectrometry method, in the fourth step, the sample ions S2 are detected by the negative ion mode. Accordingly, the sample ions S2 can be appropriately detected.

Incidentally, the sample support 1 may be used for mass spectrometry to analyze a mass spectrum. In this case, it is preferable that a solution containing the sample S is dripped onto the second surface 2b. When the sample support 1 is used for mass spectrometry to analyze a mass spectrum, highly sensitive mass spectrometry is possible, and the analysis of the mass spectrum is also facilitated.

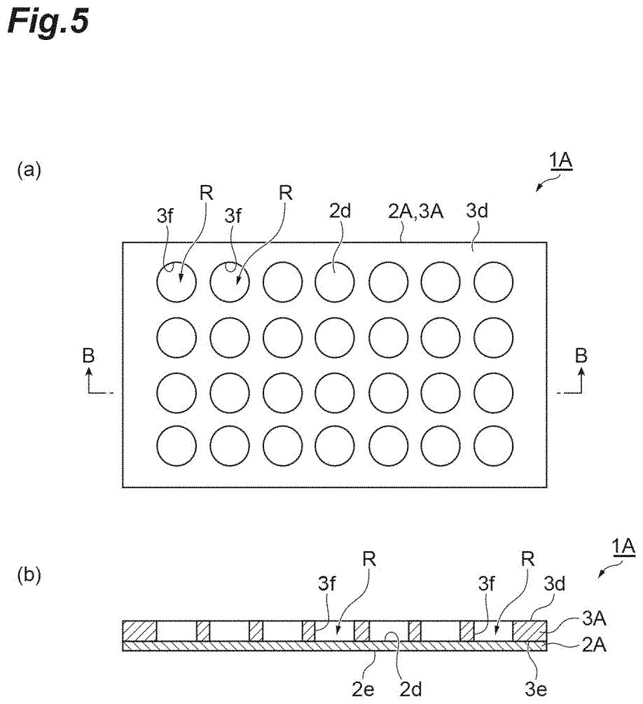

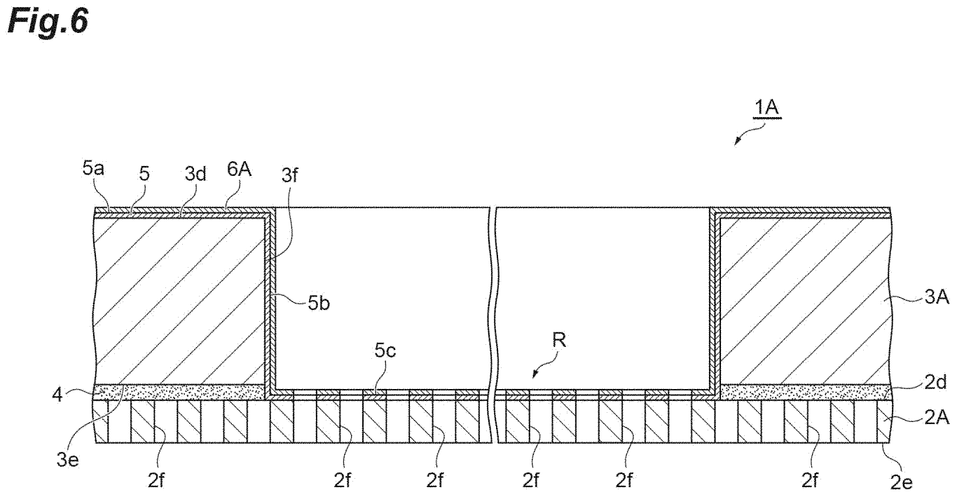

### Second Embodiment

[Configuration of sample support] As shown in (a) and (b) in FIG. 5, and FIG. 6, a sample support 1A of a second embodiment is different from the sample support 1 of the first embodiment mainly in that a substrate 2A is provided instead of the substrate 2, in that a frame 3a is provided instead of the frame 3, and in that an anionizing agent 6A is provided instead of the anionizing agent 6.

The sample support 1A includes the substrate 2A, the frame 3a, the conductive layer 5, and the anionizing agent 6A. The substrate 2A has, for example, a rectangular plate shape. A length of one side of the substrate 2A is, for example, approximately several cm. The substrate 2A has a first surface 2d, a second surface 2e, and a plurality of through-holes 2f. The frame 3a has substantially the same outer shape as that of the substrate 2A when viewed in a thickness direction of the substrate 2A. The frame 3a has a third surface 3d, a fourth surface 3e, and a plurality of openings 3f. The plurality of openings 3f define a plurality of the measurement regions R, respectively. Namely, the plurality of measurement regions R are formed in the substrate 2A. The sample S is disposed in each of the measurement regions R.

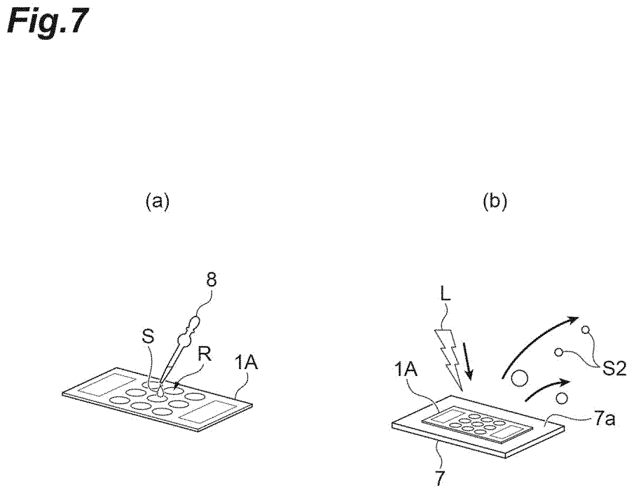

The anionizing agent 6A is provided on a first surface 2d side of the substrate 2A. The anionizing agent 6A is indirectly provided on the first surface 2d. The anionizing agent 6A is provided on the first surface 2d with the conductive layer 5 interposed therebetween. The anionizing agent 6A is directly provided on a surface on an opposite side of the conductive layer 5 from the substrate 2A. Specifically, the anionizing agent 6A is continuously (integrally) provided on a surface 5c of the conductive layer 5 which is formed in a region corresponding to each of the measurement regions R, on a surface 5b of the conductive layer 5 which is formed on an inner surface of the openings 3f, and on a surface 5a of the conductive layer 5 which is formed on the third surface 3d of the frame 3. The anionizing agent 6A covers a portion of the surface 5c of the conductive layer 5 in each of the measurement regions R, the through-hole 2f not being formed in the portion. Namely, each of the through-holes 2f is exposed to the opening 3f in each of the measurement regions R. Incidentally, in (a) and (b) in FIG. 6, the illustrations of the adhesive layer 4, the conductive layer 5, and the anionizing agent 6A are omitted.

[Ionization method and mass spectrometry method] Next, an ionization method and a mass spectrometry method using the sample support 1A will be described. First, as shown in (a) in FIG. 7, the sample support 1A is prepared (first step). Subsequently, the component of the sample S is introduced into the plurality of through-holes 2f (refer to FIG. 7) of the sample support 1A (second step). Specifically, the sample S is disposed in each of the measurement regions R of the sample support 1A. In the present embodiment, for example, a solution containing the sample S is dripped on each of the measurement regions R by a pipette 8. Accordingly, the component of the sample S is mixed with the material of the anionizing agent 6A and moves from the first surface 2d side to a second surface 2e side of the substrate 2A through the plurality of through-holes 2f. The component of the sample S stays on the first surface 2d side in a state where the component is mixed with the material of the anionizing agent 6A. Subsequently, as shown in (b) in FIG. 7, the sample support 1A into which the component of the sample S is introduced is disposed on the placement surface 7a of the slide glass 7. Subsequently, the sample support 1A is fixed to the slide glass 7 using tape having conductivity. Subsequently, the component of the sample S is ionized (third step). The above steps correspond to the ionization method using the sample support 1A. Subsequently, the released sample ions S2 are detected in the ion detection unit of the mass spectrometer (fourth step). The ion detection unit acquires a mass spectrum of the molecules constituting the sample S by detecting the sample ions S2. The above steps correspond to the mass spectrometry method using the sample support 1A.

As described above, in the sample support 1A, the plurality of measurement regions R in which the sample S is disposed are formed in the substrate 2A. According to this configuration, the ionization of the component of the sample S can be performed in each of the plurality of measurement regions R.

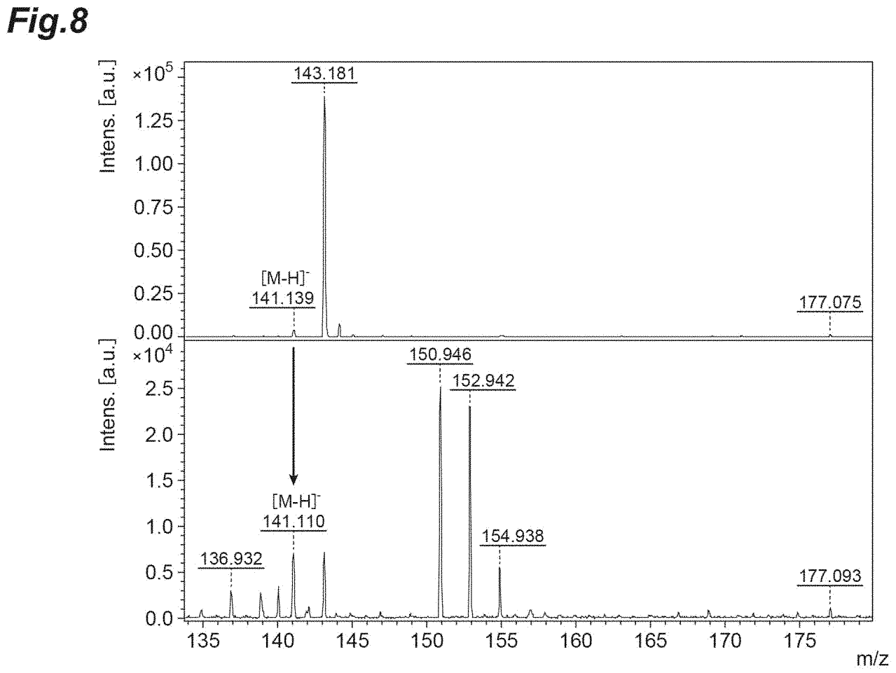

(a) in FIG. 8 is a graph showing a mass spectrum obtained by a mass spectrometry method of a comparative example. (b) in FIG. 8 is a graph showing a mass spectrum obtained by a mass spectrometry method of an example. A sample support used in the mass spectrometry method of the comparative example is different from the sample support 1A in that the anionizing agent 6A is not provided. The rest of the mass spectrometry method of the comparative example is the same as that of the mass spectrometry method of the example. As shown in (a) and (b) in FIG. 8, a detection intensity of ions in the mass spectrometry method of the example is larger than a detection intensity of ions in the mass spectrometry method of the comparative example. In a region where a molecular weight is approximately m/z 140, the detection intensity of the example is approximately 7 or more times the detection intensity of the comparative example. As described above, according to the sample support 1A, highly sensitive mass spectrometry is possible, and the analysis of the mass spectrum is also facilitated.

### MODIFICATION EXAMPLES

The present disclosure is not limited to each of the above-described embodiments. In the first embodiment, an example has been provided in which the anionizing agent 6 is directly provided on the second surface 2b, but the anionizing agent 6 may be indirectly provided on the second surface 2b with, for example, the conductive layer or the like interposed therebetween.

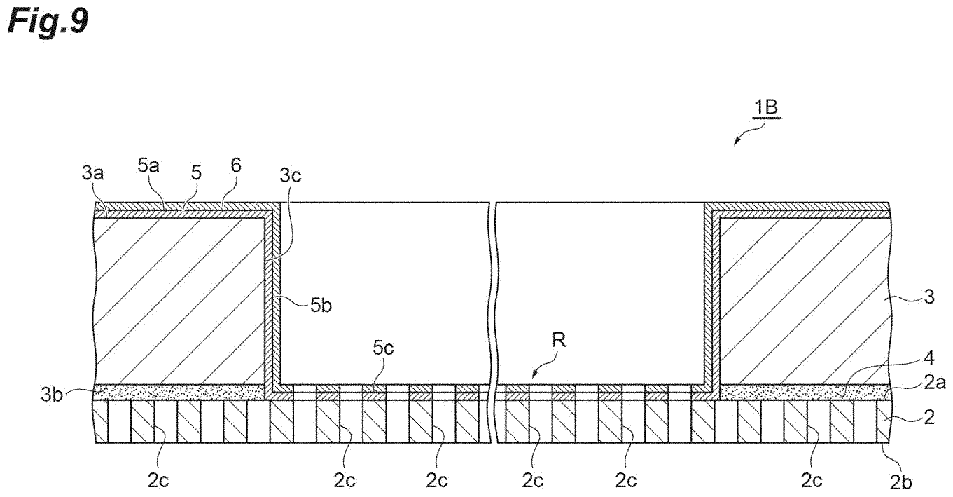

In addition, in the first embodiment, an example has been provided in which the anionizing agent 6 is provided on the second surface 2b side of the substrate 2, but the present disclosure is not limited to the example. As shown in FIG. 9, in a sample support 1B, the anionizing agent 6 may be provided on the first surface 2a side. The anionizing agent 6 is indirectly provided on the first surface 2a. The anionizing agent 6 is provided on the first surface 2d with the conductive layer 5 interposed therebetween. The anionizing agent 6 is directly provided on the surface on the opposite side of the conductive layer 5 from the substrate 2. Specifically, the anionizing agent 6 is continuously (integrally) provided on the surface 5c of the conductive layer 5 which is formed in the region corresponding to the measurement region R, on the surface 5b of the conductive layer 5 which is formed on the inner surface of the opening 3c, and on the surface 5a of the conductive layer 5 which is formed on the third surface 3a of the frame 3. The anionizing agent 6 covers a portion of the surface 5c of the conductive layer 5 in the measurement region R, the through-holes 2c not being formed in the portion. Namely, each of the through-holes 2c is exposed to the opening 3c in the measurement region R. According to this configuration, mass spectrometry to analyze a mass spectrum can be performed with high sensitivity. Namely, for example, both when the component S1 of the sample S in a liquid state is introduced into each of the through-holes 2c from the first surface 2a side and when the component S1 of the sample S in a liquid state is introduced into each of the through-holes 2c from the second surface 2b side, the component S1 of the sample S stays on the first surface 2a side in a state where the component S1 is reliably mixed with the material 61 of the anionizing agent 6. For this reason, the component S1 can be reliably anionized, and mass spectrometry can be performed with high sensitivity. Incidentally, the anionizing agent 6 may be directly provided on the first surface 2d. In this case, the conductive layer 5 may be provided on a surface of the anionizing agent 6.

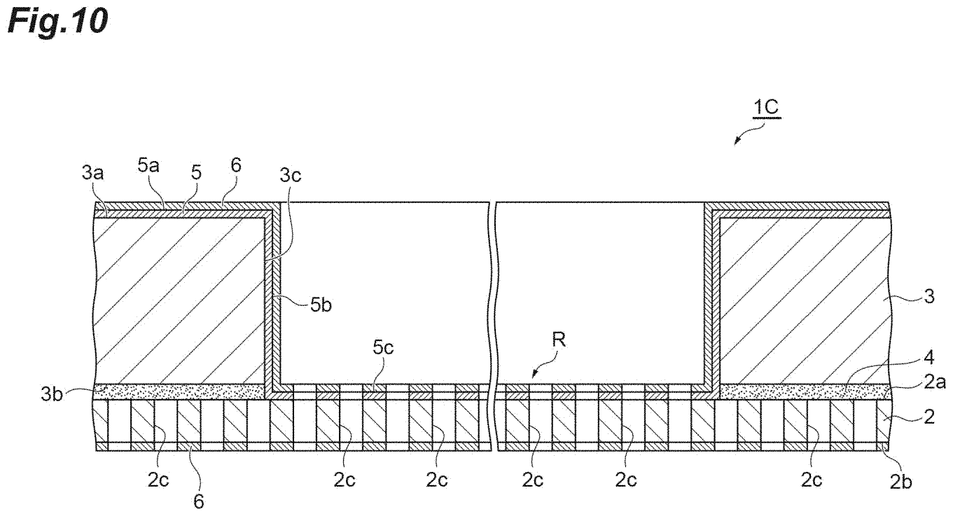

In addition, as shown in FIG. 10, in a sample support 1C, the anionizing agent 6 may be provided on the second surface 2b side similarly to the sample support 1 and on the first surface 2a side similarly to the sample support 1B. According to this configuration, both image mass spectrometry and mass spectrometry to analyze a mass spectrum can be performed with high sensitivity.

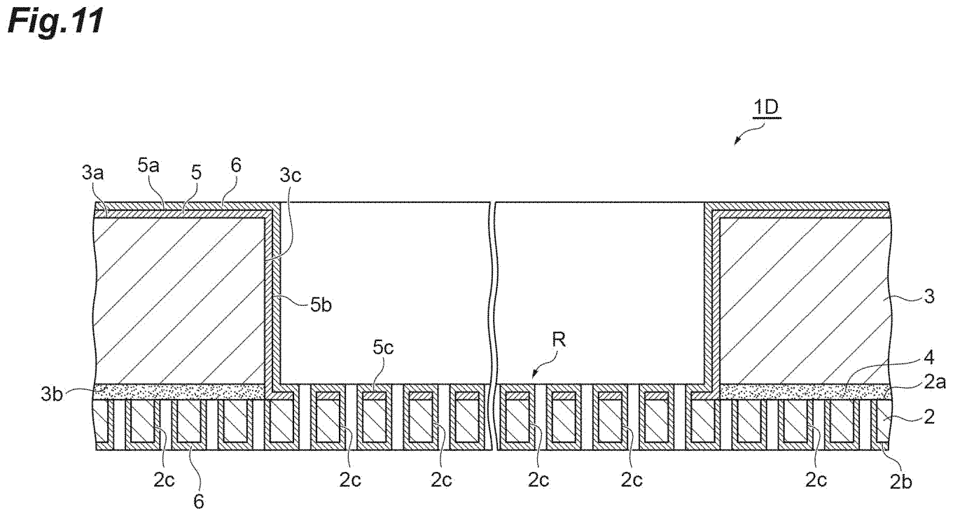

In addition, as shown in FIG. 11, in a sample support 1D, the anionizing agent 6 may be provided on the first surface 2a side similarly to the sample support 1B, on the second surface 2b side similarly to the sample support 1, and on inner surfaces of the plurality of through-holes 2c. The anionizing agent 6 is directly provided on the inner surfaces of the plurality of through-holes 2c. In this case, the anionizing agent 6 is formed by the atomic deposition method and has such a thickness that the through-holes 2c are not blocked. Namely, since the thickness of the anionizing agent 6 is sufficiently small, the conductive layer 5 is allowed to appropriately function. In addition, the anionizing agent 6 may be provided on only the inner surfaces of the plurality of through-holes 2c. Incidentally, the anionizing agent 6 may be indirectly provided on the inner surfaces of the plurality of through-holes 2c with, for example, the conductive layer or the like interposed therebetween.

In addition, an example has been provided in which the anionizing agent 6 is provided as an evaporation film, a sputtering film, or an atomic deposition film, but the anionizing agent 6 may be provided as, for example, a coating dry film. Specifically, the anionizing agent 6 can be formed, for example, by coating the substrate 2 with a material in a liquid state containing the anionizing agent 6 using a spray or the like and then by drying the coated substrate 2. In this case, an average grain size of the crystals of the anionizing agent 6 is, for example, approximately several tens of μm. The average grain size of the crystals of the anionizing agent 6 is a value measured by SEM. According to this configuration, the anionizing agent 6 can be easily provided. Similarly, the anionizing agent 6A may also be provided as, for example, a coating dry film.

In addition, an example has been provided in which the deprotonation of the component S1 is promoted by the anionizing agent 6, but the anionizing agent 6 may add a halide (for example, Cl, Br, or the like) to the component S1. The anionizing agent 6 may function to add a halide to the component S1 of the sample S. In this case, the anionizing agent 6 is, for example, a chloride, a bromide, or the like, and the component S1 of the sample S is detected as halide adduct ions to which the halide is added.

In addition, the substrate 2 may have conductivity. In the mass spectrometry method, the first surface 2a may be irradiated with the laser light L while a voltage is applied to the substrate 2. When the substrate 2 has conductivity, in the sample support 1, the conductive layer 5 can be omitted, and the same effects as when the sample support 1 including the conductive layer 5 described above is used can be obtained. Incidentally, the fact that the first surface 2a is irradiated with the laser light L means that the conductive layer 5 is irradiated with the laser light L when the sample support 1 includes the conductive layer 5, and means that the first surface 2a of the substrate 2 is irradiated with the laser light L when the substrate 2 has conductivity. Similarly, the substrate 2A may also have conductivity.

In addition, an example has been provided in which the plurality of through-holes 2c are formed in the entirety of the substrate 2, but the plurality of through-holes 2c may be formed in at least a portion of the substrate 2 corresponding to the measurement region R. Similarly, the plurality of through-holes 2f may be formed in at least a portion of the substrate 2A corresponding to the measurement regions R.

In addition, in the first embodiment, the sample S is not limited to a hydrous sample and may be a dry sample. When the sample S is a dry sample, a solution for lowering a viscosity of the sample S (for example, an acetonitrile mixture or the like) is added to the sample S. Accordingly, the component S1 of the sample S can move to the first surface 2a side of the substrate 2 through the plurality of through-holes 2c because of, for example, a capillary phenomenon.

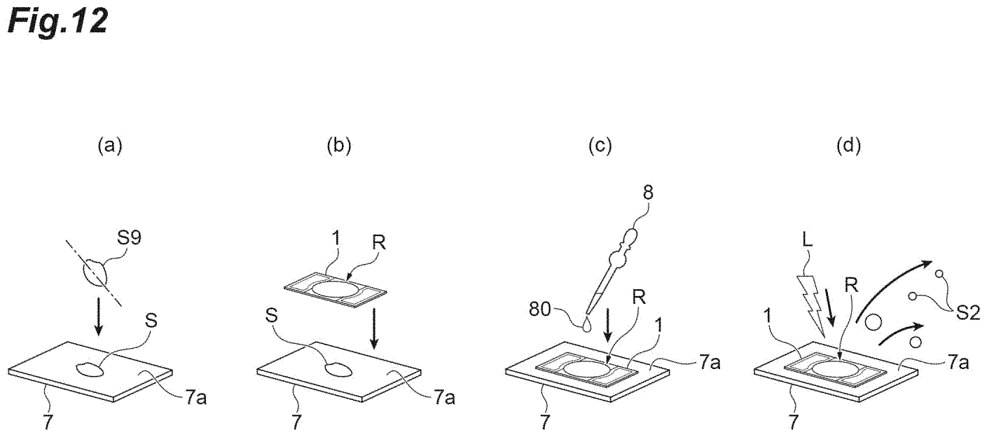

Specifically, first, the sample support 1 is prepared. Subsequently, as shown in (a) and (b) in FIG. 12, the component of the sample S is introduced into the plurality of through-holes 2c (refer to FIG. 2) of the sample support 1. Specifically, the sample S is disposed on the placement surface 7a of the slide glass 7. The sample S is, for example, a thin film-shaped biological sample (dry sample) such as a tissue section and is acquired by slicing a biological sample S9.

Subsequently, the sample support 1 is disposed on the placement surface 7a such that the second surface 2b (refer to FIG. 2) of the sample support 1 faces the sample S and the anionizing agent 6 (refer to FIG. 2) comes into contact with the sample S. Subsequently, the sample support 1 is fixed to the slide glass 7 using tape having conductivity. Subsequently, as shown in (c) in FIG. 12, for example, a solvent 80 is dripped on the measurement region R by the pipette 8. Accordingly, the component of the sample S is mixed with the solvent 80 and with a part of the anionizing agent 6 and moves from the second surface 2b side to the first surface 2a side of the substrate 2 through the plurality of through-holes 2c (refer to FIG. 2). The component of the sample S stays on the first surface 2a side in a state where the component is mixed with the part of the anionizing agent 6. Subsequently, as shown in (d) in FIG. 12, the component of the sample S is ionized (third step). Subsequently, the released sample ions S2 are detected in the ion detection unit of the mass spectrometer (fourth step).

In addition, in the first embodiment, the mass spectrometer may be a scanning type mass spectrometer or a projection type mass spectrometer. In the case of the scanning type, a signal of one pixel having a size corresponding to a spot diameter of the laser light L is acquired for each one irradiation with the laser light L performed by the irradiation unit. Namely, scanning (irradiation position is changed) and irradiation with the laser light L are performed for each one pixel. On the other hand, in the case of the projection type, a signal of an image (plurality of pixels) having a size corresponding to the spot diameter of the laser light L is acquired every time the irradiation unit performs irradiation with the laser light L. In the case of the projection type, when the spot diameter of the laser light L includes the entirety of the measurement region R, imaging mass spectrometry can be performed by one irradiation with the laser light L. Incidentally, in the case of the projection type, when the spot diameter of the laser light L does not include the entirety of the measurement region R, a signal of the entirety of the measurement region R can be acquired by performing scanning and irradiation with the laser light L similarly to the scanning type.

In addition, when the sample support 1A, 1B, 1C, or 1D is used, the component of the sample S may not be mixed with a part of the anionizing agent 6A or 6. In this case, when the first surface 2a of the substrate 2 is irradiated with the laser light L while a voltage is applied to the conductive layer 5, the component of the sample S and the part of the anionizing agent 6A or 6 evaporate, and the component of the sample S is anionized (including deprotonation or halide addition) in a gas phase.

### REFERENCE SIGNS LIST

1, 1A, 1B, 1C, 1D: sample support, 2, 2A: substrate, 2a, 2d: first surface, 2b, 2e: second surface, 2c, 2f: through-hole, 5: conductive layer, 5c: surface, 6, 6A: anionizing agent, L: laser light (energy ray), R: measurement region, S: sample, S1: component, S2: sample ion.

1. A sample support used for ionizing a component of a sample, the support comprising:
a substrate having a first surface, a second surface opposite the first surface, and a plurality of through-holes that are open on the first surface and on the second surface;
a conductive layer provided on at least the first surface; and
an anionizing agent provided in the plurality of through-holes to anionize the component.

2. The sample support according to claim 1,
wherein the anionizing agent is provided on at least the second surface side.

3. The sample support according to claim 1,
wherein the anionizing agent is provided on at least the first surface side.

4. The sample support according to claim 1,
wherein the anionizing agent is provided on at least the second surface side and the first surface side.

5. The sample support according to any one of claims 1 to 4 claim 1,
wherein the anionizing agent is provided as an evaporation film, a sputtering film, or an atomic deposition film.

6. The sample support according to claim 1,
wherein the anionizing agent is provided as a coating dry film.

7. The sample support according to claim 1,
wherein the anionizing agent contains at least one selected from a fluoride, a chloride, a bromide, and an iodide.

8. The sample support according to claim 1,
wherein a plurality of measurement regions in which the sample is disposed are formed in the substrate.

9. A sample support used for ionizing a component of a sample, the support comprising:
a substrate having conductivity and having a first surface, a second surface opposite the first surface, and a plurality of through-holes that are open on the first surface and on the second surface; and
an anionizing agent provided in the plurality of through-holes to anionize the component.

10. An ionization method comprising:
a first step of preparing the sample support according to claim 1;
a second step of introducing the component of the sample into the plurality of through-holes; and
a third step of ionizing the component of the sample by irradiating the first surface with an energy ray while applying a voltage to the conductive layer.

11. An ionization method comprising:
a first step of preparing the sample support according to claim 9;
a second step of introducing the component of the sample into the plurality of through-holes; and
a third step of ionizing the component of the sample by irradiating the first surface with an energy ray while applying a voltage to the substrate.

12. A mass spectrometry method comprising:
each step of the ionization method according to claim 10; and
a fourth step of detecting the ionized component.

13. The mass spectrometry method according to claim 12,
wherein in the fourth step, the ionized component is detected by a negative ion mode.

14. A mass spectrometry method comprising:
each step of the ionization method according to claim 11; and
a fourth step of detecting the ionized component.
